(19) United States
(12) Patent Application Publication
(10) Pub. No.: US 2022/0309893 A1
(43) Pub. Date: Sep. 29, 2022

(54) Preemptive Personal Safety System

(71) Applicants: Robert L, Terry, Houston, TX (US); M. Harris Milam, Houston, TX (US); Starla L. Terry, Austin, TX (US)

(72) Inventors: Robert L, Terry, Houston, TX (US); M. Harris Milam, Houston, TX (US); Starla L. Terry, Austin, TX (US)

(21) Appl. No.: 17/697,521

(22) Filed: Mar. 17, 2022

Related U.S. Application Data
(60) Provisional application No. 63/166,091, filed on Mar. 25, 2021.

(51) Int. Cl. G08B 15/00; G08B 5/38

(52) U.S. Cl. CPC G08B 15/004; G08B 5/38

(57) ABSTRACT

The invention is a psychological system that combines a personal protection device with a clearly identifiable static display to show that recording of actions and identities is highly likely.

It is a multipurpose system, operating as a personal security device with pulsating red and blue lights as a visible warning, a video system recording identities and criminal or abusive behavior; as a vehicle security system with a rear vehicle reflective display sticker showing that recording of actions and identities is highly likely, with a personal protection device in the vehicle on the driver's wrist; a system that works like a home security device with a preemptive yard sign indicating the presence of technical security within the home.

If a crime is committed, the video and audio recording will reveal the time, the person's identity, and actions to provide for criminal prosecution. Thus, it preemptively and non-confrontationally discourages criminal and abusive behavior. Its intent is a passive deterrent rather than physical defense. The recording is archived, and provides evidence for a quick investigative response.

### U.S. PATENT DOCUMENTS

This patent claims the benefit of U.S. provisional patent No. 63/166,091 filed on Mar. 25, 2021.

| | | | | |
|---|---|---|---|---|
| 9,325,824 | July 2015 | McLaughlin | Adjustable holder for portable de- | H04M 1/5041 |
| | | | vice with sound enhancement | |
| 9,615,235 | April 2017 | Scully | Wireless personal safety device | H04W 4/22 |
| 2017/0111606 | April 2017 | Davis | Article of clothing with video | H04N 5/772 |
| | | | recording device support | |
| 9,522,937 | May 2018 | Shah | Wearable multi-sensory personal | G08B 25/01 |
| | | | safety and tracking device | |

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### STATEMENT REGARDING PRIOR DISCLOSURE BY THE INVENTOR

There have been no prior disclosures by the inventors.

### BACKGROUND OF THE INVENTION

There are many inventions providing personal safety devices. The U.S. Pat. No. 9,615,235 by Jack T. Scully, et al. references a number of patents for such devices and has a discussion of the importance of personal protection. Many modern inventions for personal protection have means for recording, storing, and transmitting (e.g., to remote storage facilities) sounds and images of actions. For simplicity, in the following the term “personal safety device,” with the abbreviation “PSD,” will be used for such devices. The term includes devices that are combined with cell telephones, the latter providing storage and communication facilities to the basic device. The part of a PSD other than a cell telephone will be called a “basic personal safety device,” abbreviated “BPSD.”

Studies show that a major deterrent to criminal behavior is the fear of being caught. It is well-known and documented that a person warned that his or her identity and actions are being recorded will stop to consider the legal consequences of those actions. This psychological method is the basis for the present invention.

In keeping with this psychological method, the present invention includes a wearable smart device with a strobe type two light system that is based on a light system used by law enforcement (i.e., red and blue flashing light system in the USA, blue and white flashing light system in Europe). The present invention is a psychological system and method that is likely to cause an uncharacteristic deviation from criminal or unacceptable behavior.

Thus, a complete PSD system has a BPSD wirelessly linked to a smartphone having software (an “app”) providing control of the BPSD, storage of audio and video data, and communication. The latter provides a means for transmitting sound and image information to a remote site (for example, in the Internet cloud). This allows later retrieval in case the smartphone is lost or damaged.

### BRIEF SUMMARY OF THE INVENTION

In further keeping, with a psychological principle, the present invention includes a reflective warning label as an attachment to the rear of a vehicle to provide a warning that the vehicle is carrying a PSD. This works like the popular deterrent method of a security yard sign.

Flashing strobe lights may not be appropriate under some conditions such as office or work-place. In these circumstances, a wrist band basic personal security device (BSPD) worn or placed in a position for good surveillance of aggressive behavior would be a deterent. Lights may be turned off and the recording on to discourage harassment. This would eliminate “she said/he said” testimony conflicts.

The present system combines a personal security device (PSD) with a clearly identifiable warning light and warning label indicating that recording of identities and activities is highly likely. Thus, it is preemptive and non-confrontationally disruptive of criminal and abusive behavior. For example, the PSD on a wrist band can be seen from most directions and it can be positioned for recording assailants. In a typical application when the user is in an environment or situation that may require a method of personal security, the user places the (PSD) on the wrist. The motion makes the lights identifiable from all directions and allows the recording of identities and actions of potential assailants at any angle. The design is to deter rather than defend. Many individuals (men, women, and children) would prefer this passive method of personal security.

Drivers and passengers of all types of vehicles will be protected if at least one of them wears a wristband PSD. The reflective rear vehicle warning label advertises this protection for the occpants.

Of course, in order for the warning label to be effective, its purpose and appearance must be widely known. It will be important in marketing the system to widely advertise the appearance and purpose of the vehicle label and for company recognition and product promotion.

### BRIEF DESCRIPTION OF THE SEVERAL VIEWS OF THE DRAWINGS

FIG. 1. Overview of the system, showing the personal safety device comprising a basic personal safety device and a cell telephone with light warning system and a reflective warning vehicle label.

### DETAILED DESCRIPTION OF THE INVENTION

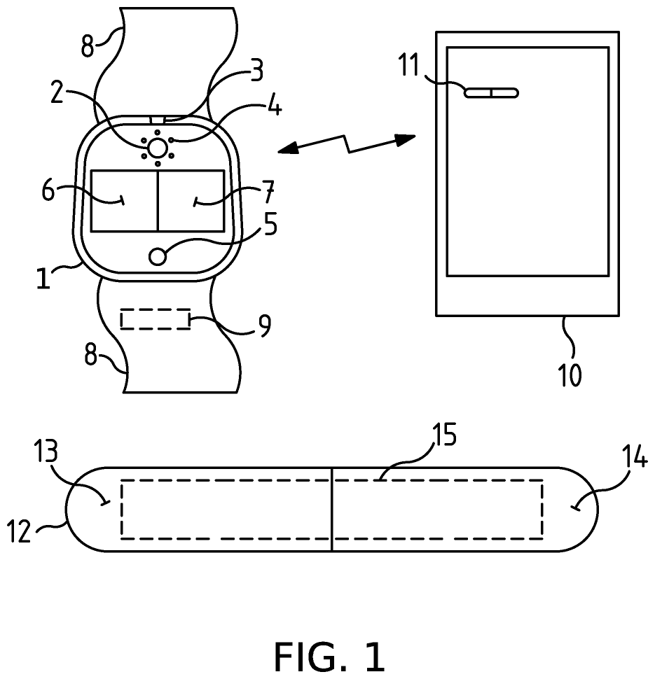

This invention comprises a personal safety device and one or more warning elements. As shown in FIG. 1, one preferred embodiment of a personal safety device has a basic personal safety device (BPSD) 1 and a cell telephone 10, the two parts being linked wirelessly as shown by the double arrow. The BPSD can be any appropriate device such as is described in U.S. Pat. No. 9,615,235 by Jack T. Scully, provided it is configured as described below.

It is not the intent of this patent to describe the details of the BPSD, except for its external appearance and features so that it will match the warning label. In one preferred embodiment, as shown in FIG. 1, the BPSD 1 has the following external features: a video camera lens 2; a white LED 3, indicating that the system is active; an array of infrared LEDs 4 providing light for the video camera; a microphone 5 for recording sound; two large alternately-strobing colored lights 6 and 7 warning that surveillance is active; a reflective wrist band 8; and an identifying logo 9 in large letters.

The cell telephone 10 is shown displaying the icon 11 for the app which activates the BPSD and transmits data to the Internet cloud; it resembles the warning label 12.

A preferred embodiment of the warning label is seen as 12 at the bottom of FIG. 1. It has two large reflective areas 13 and 14, an identifying logo 15. The intent is an appearance that suggests that of the BPSD. Physically, it can be a simple sticker, or a more substantial metal-plate based sign.

1. A basic personal safety device; mountable on a human by wrist strap, clothing clip, or other means; with an internal microcomputer wirelessly-linkable to a smart phone; and having the following features controlling, controlled by, and/or acquiring audio and video data for said microcomputer: a microphone, a video camera, an array of infrared LEDs providing light for the video camera, two large colored lights, and a white LED.

2. A basic personal safety device as in claim 1 with a wrist strap, said wrist strap having a reflective surface and a logo indicating the nature of the basic personal safety device.

3. A basic personal safety device as in claim 1 with a clip for attaching said device to a persons clothing.

4. A vehicle-attachable reflective warning label indicating the presence of a basic personal safety device, and having an appearance suggestive of that of said device.
